(19) United States
(12) Patent Application Publication
(10) Pub. No.: US 2024/0045582 A1
(43) Pub. Date: Feb. 8, 2024

(54) IMAGE DETERMINATION METHOD, INFORMATION PROCESSING APPARATUS, AND NON-TRANSITORY COMPUTER-READABLE STORAGE MEDIUM STORING PROGRAM

(71) Applicant: SEIKO EPSON CORPORATION, Tokyo (JP)

(72) Inventors: Takashi NATORI, Suwa-shi (JP); Sayaka ARIMOTO, Azumino-shi (JP)

(21) Appl. No.: 18/365,321

(22) Filed: Aug. 4, 2023

(30) Foreign Application Priority Data
Aug. 4, 2022 (JP) 2022-124600

(51) Int. Cl. G06F 3/04845; G06F 3/14

(52) U.S. Cl. CPC G06F 3/04845; G06F 3/14

(57) ABSTRACT

An image determination method includes acquiring operation information concerning operation by a first user in a state in which an image including a plurality of item images is displayed; and, when detecting, based on the operation information, a state in which the first user cannot determine on which item image among the plurality of item images the first user performs operation, determining, based on operation history information, at least one item image to be recommended as a target on which the first user perform operation among the plurality of item images, the operation history information being information concerning an item image which has been a target of operation performed by at least one of the first user and a second user different from the first user in the state in which the image including the plurality of item images is displayed.

The present application is based on, and claims priority from JP Application Serial Number 2022-124600, filed Aug. 4, 2022, the disclosure of which is hereby incorporated by reference herein in its entirety.

### BACKGROUND

### 1. Technical Field

The present disclosure relates to an image determination method, an information processing apparatus, and a non-transitory computer-readable storage medium storing a program.

### 2. Related Art

A user is sometimes confused about operation of an apparatus, application software, or the like. A cause of the confusion about the operation is considered to be that, for example, an operation method is unclear, the operation method is complicated, or the user is unaccustomed to the operation. A technique for supporting the operation by the user when the user is confused about the operation in this way has been developed. For example, JP-A-2016-57854 (Patent Literature 1) discloses an operation supporting system that determines, based on operation information of software collected using Cloud computing and information concerning operation of the software by the user, whether the user is confused. When determining that the user is confused, the operation supporting system presents help information stored in a help information storage to the user.

Patent Literature 1 does not disclose a determination method for help information to be presented to the user. For this reason, information to be presented to the user is sometimes not appropriately determined. Therefore, even if the user checks presented help information, the user sometimes cannot grasp an operation method. As a result, a confused state is not eliminated.

### SUMMARY

An image determination method according to an aspect of the present disclosure includes: acquiring operation information concerning operation by a first user in a state in which an image including a plurality of item images is displayed; and, when detecting, based on the operation information, a state in which the first user cannot determine on which item image among the plurality of item images the first user performs operation, determining, based on operation history information, at least one item image to be recommended as a target on which the first user perform operation among the plurality of item images, the operation history information being information concerning an item image which has been a target of operation performed by at least one of the first user and a second user different from the first user in the state in which the image including the plurality of item images is displayed.

An information processing apparatus according to an aspect of the present disclosure includes a processing device, the processing device executing: acquiring operation information concerning operation by a first user in a state in which an image including a plurality of item images is displayed; and, when detecting, based on the operation information, a state in which the first user cannot determine on which item image among the plurality of item images the first user performs operation, determining, based on operation history information, at least one item image to be recommended as a target on which the first user perform operation among the plurality of item images, the operation history information being information concerning an item image which has been a target of operation performed by at least one of the first user and a second user different from the first user in the state in which the image including the plurality of item images is displayed.

A non-transitory computer-readable storage medium storing a program, the program causing a processing device to execute: acquiring operation information concerning operation by a first user in a state in which an image including a plurality of item images is displayed; and, when detecting, based on the operation information, a state in which the first user cannot determine on which item image among the plurality of item images the first user performs operation, determining, based on operation history information, at least one item image to be recommended as a target on which the first user perform operation among the plurality of item images, the operation history information being information concerning an item image which has been a target of operation performed by at least one of the first user and a second user different from the first user in the state in which the image including the plurality of item images is displayed.

### BRIEF DESCRIPTION OF THE DRAWINGS

FIG. 1 is a schematic diagram for explaining a notification system according to a first embodiment.

FIG. 2 is a schematic diagram illustrating an example of an operation image displayed on a touch panel.

FIG. 3 is a schematic diagram illustrating an example of an operation image displayed on a touch panel.

FIG. 4 is a block diagram illustrating a configuration of the notification system according to the first embodiment.

FIG. 5 is a block diagram illustrating a configuration of a storage device according to the first embodiment.

FIG. 6 is a flowchart for explaining an operation of a server according to the first embodiment.

FIG. 7 is a flowchart for explaining operation target determination processing.

FIG. 8 is a block diagram illustrating a configuration of a smartphone according to a second embodiment.

FIG. 9 is a block diagram illustrating a configuration of a storage device according to the second embodiment.

FIG. 10 is a flowchart for explaining an operation of the smartphone according to the second embodiment.

FIG. 11 is a schematic diagram for explaining a notification image.

FIG. 12 is a schematic diagram for explaining a notification image.

FIG. 13 is a schematic diagram for explaining an operation image.

FIG. 14 is a schematic diagram for explaining a notification image.

FIG. 15 is a schematic diagram for explaining an operation image.

### DESCRIPTION OF EMBODIMENTS

Preferred embodiments of the present disclosure are explained below with reference to the accompanying drawings. In the drawings, dimensions and scales of units are sometimes different from actual ones. Some portions are schematically illustrated in order to facilitate understanding. The scope of the present disclosure are not limited to these forms unless it is particularly described in the following explanation that the present disclosure is limited.

### 1. First Embodiment

In a first embodiment, an image determination method, an information processing apparatus, and a non-transitory computer-readable storage medium storing a program according to the present disclosure are explained by illustrating a notification system including a smartphone operated by a user and a server that acquires information concerning the operation by the user from the smartphone and determines, based on the information, whether the user is confused about the operation. When detecting a state in which the user is confused, the server according to this embodiment determines, based on an operation history of one or a plurality of users including the user, notification content for supporting the operation by the user. The smartphone according to this embodiment supports the operation by the user by displaying an image based on the notification content determined by the server.

### 1.1. Overview of a Notification System

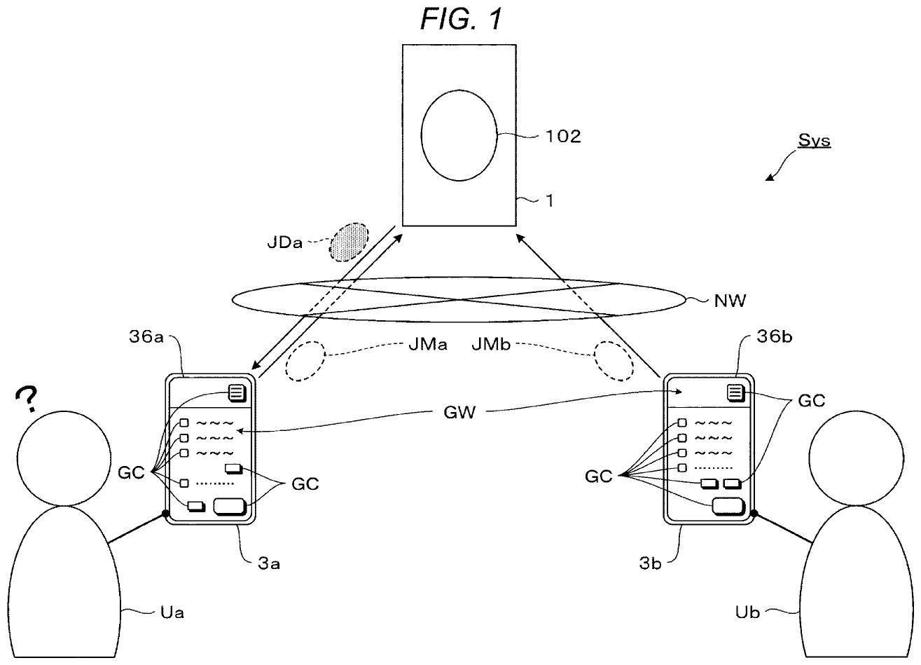

FIG. 1 is a schematic diagram for explaining a notification system Sys according to the first embodiment. The notification system Sys includes a server 1, a smartphone 3a, and a smartphone 3b. The server 1 stores operation history information 102. The smartphone 3a includes a touch panel 36a. The smartphone 3a causes the touch panel 36a to display an operation image GW including a plurality of item images GC. The respective plurality of item images GC are images showing buttons for executing predetermined functions, check boxes, radio buttons, scroll bars, and the like. For example, a user Ua touches the touch panel 36a to execute operation for pressing the item image GC, operation for swiping the operation image GW, or the like. The smartphone 3b includes a touch panel 36b. Like the smartphone 3a, the smartphone 3b causes the touch panel 36b to display an operation image GW including a plurality of item images GC. Like the user Ua, for example, a user Ub touches the touch panel 36b to execute operation for pressing the item image GC, operation for swiping the operation image GW, or the like. A display form of the operation image GW displayed on the touch panel 36a and a display form of the operation image GW displayed on the touch panel 36b are sometimes different from each other. In some cases, the display form of the operation image GW changes according to an operation stage or the operation image GW is switched to another operation image GW.

The server 1 acquires operation information JMa from the smartphone 3a via a network NW. The operation information JMa is information concerning operation executed by the user Ua on the smartphone 3a in a state in which the operation image GW is displayed on the touch panel 36a. The operation information JMa includes, for example, information indicating the operation image GW displayed on the touch panel 36a when the operation is executed, information indicating a position on the touch panel 36a where the operation is received, information indicating the item image GC set as a target of the operation, information indicating the number of times of operation performed from a certain point in time, and information indicating a time consumed from certain operation to the next operation. When the operation image GW is a GUI (Graphical User Interface) used when a specific apparatus is operated, the operation information JMa includes information concerning a type and a model number of the apparatus. When the operation image GW is a GUI used when specific application software is operated, the operation information JMa includes information indicating a version of the application software. The operation information JMa may be transmitted to the server 1 every time the number of times of the operation executed on the smartphone 3a by the user Ua reaches predetermined number of times or may be transmitted at a predetermined time interval. In the following explanation, the information indicating the item image GC set as the target of the operation is sometimes referred to as “target information”. The information indicating the number of times of operation performed from a certain point in time is sometimes referred to as “number of times information”. The information indicating a time consumed from certain operation to the next operation is sometimes referred to as “time information”.

The server 1 acquires operation information JMb from the smartphone 3b via the network NW. The operation information JMb is information concerning operation executed on the smartphone 3b by the user Ub in a state in which the operation image GW is displayed on the touch panel 36b. The operation information JMb includes the same information as the information included in the operation information JMa. For example, the operation information JMb includes target information.

The server 1 determines, based on the operation information JMa, whether the user Ua is confused about operation. Specifically, the server 1 determines whether the user Ua is in a state in which the user Ua cannot determine on which item image among the plurality of item images GC included in the operation image GW the user Ua performs operation.

When determining that the user Ua is confused about operation, that is, the user Ua cannot determine on which item image among the plurality of item images GC the user Ua performs operation, the server 1 determines, based on the operation history information 102, notification content for supporting operation by the user Ua. Specifically, the server 1 determines, based on the operation history information 102, at least one item image GC to be a target on which the user Ua is urged to perform operation among the plurality of item images GC.

The operation history information 102 is information concerning the item image GC set as a target of operation performed by at least one of the user Ua and the user Ub in a state in which the operation image GW is displayed. The server 1 updates the operation history information 102 based on the operation information JMa and the operation information JMb. That is, the operation history information 102 includes various kinds of information included in the operation information JMa and the operation information JMb. For example, the operation history information 102 includes target information.

When at least one item image GC to be a target on which the user Ua is urged to perform operation among the plurality of item images GC is determined, the server 1 transmits instruction information JDa to the smartphone 3a. In other words, when at least one item image GC to be recommended as a target image on which user Ua perform operation among the plurality of item images GC is determined, the server 1 transmits instruction information JDa to the smartphone 3a. The instruction information JDa is information for causing the smartphone 3a to notify, to the user Ua, notification content for supporting operation by the user Ua, that is, the determined at least one item image GC. The smartphone 3a causes, based on the instruction information JDa, the touch panel 36a to display an image for notifying the determined at least one item image GC to the user Ua. The user Ua becomes capable of grasping an operation method by checking the item image GC indicated by the image displayed based on the instruction information JDa. The user Ua can eliminate confusion.

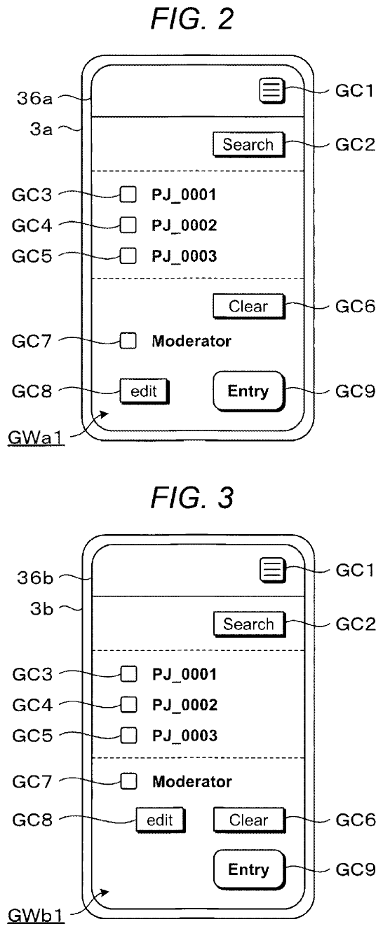

FIG. 2 is a schematic diagram illustrating an example of the operation image GW displayed on the touch panel 36a. An operation image GWa1 is displayed on the touch panel 36a as the operation image GW. FIG. 3 is a schematic diagram illustrating an example of the operation image GW displayed on the touch panel 36b. An operation image GWb1 is displayed on the touch panel 36b as the operation image GW. Each of the operation image GWa1 and the operation image GWb1 includes item images GC1 to GC9 as the plurality of item images GC. A display form of the operation image GWa1 and a display form of the operation image GWb1 are different from each other.

### 1.2. Configuration and Functions of the Notification System

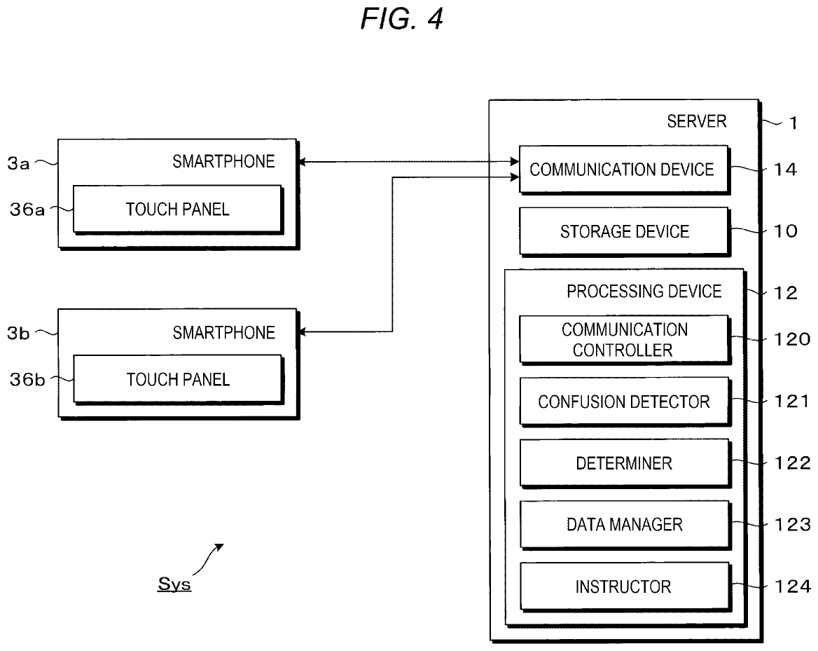

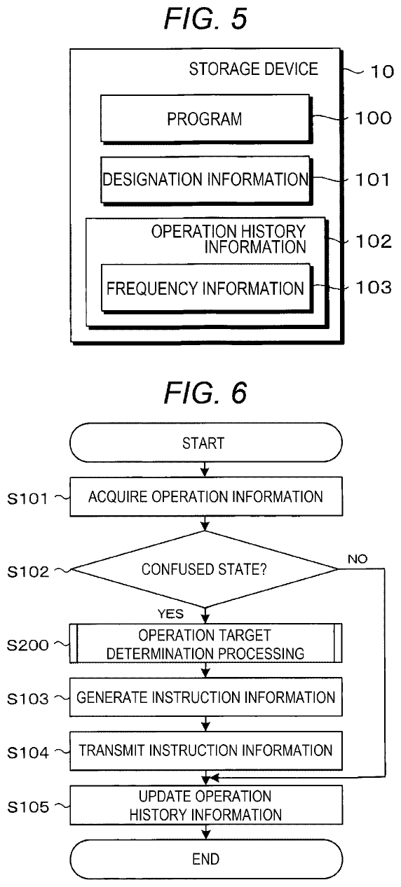

A configuration and functions of the notification system Sys according to the first embodiment are explained below with reference to FIGS. 4 and 5.

FIG. 4 is a block diagram illustrating a configuration of the notification system Sys according to the first embodiment. The server 1 includes a storage device 10 that stores various kinds of information, a processing device 12 that controls the operation of the server 1, and a communication device 14 that executes communication with terminal devices including the smartphone 3a and the smartphone 3b, an external storage device, and the like. The processing device 12 includes functions of a communication controller 120, a confusion detector 121, a determiner 122, a data manager 123, and an instructor 124.

The storage device 10 includes, for example, a volatile memory such as a RAM and a nonvolatile memory such as a ROM. RAM is an abbreviation of Random Access Memory. ROM is an abbreviation of Read Only Memory.

FIG. 5 is a block diagram illustrating a configuration of the storage device 10 according to the first embodiment. The nonvolatile memory included in the storage device 10 stores a program 100 for specifying an operation of the server 1, designation information 101 for designating predetermined item images GC among the plurality of item images GC, and operation history information 102. The operation history information 102 includes frequency information 103 indicating frequencies of operation for the respective plurality of item images GC by at least one of the user Ua and the user Ub. That is, the frequency information 103 includes information indicating the number of times of operation performed on the respective plurality of item images GC by at least one of the user Ua and the user Ub.

The volatile memory included in the storage device 10 is used by the processing device 12 as a work area at the time when the program 100 is executed.

A part or the entire storage device 10 may be provided in an external storage device, an external server, or the like. A part or all of various kinds of information stored in the storage device 10 may be stored in the storage device 10 in advance or may be acquired from the external storage device, the external server, or the like.

The processing device 12 includes one or a plurality of CPUs. However, the processing device 12 may include a programmable logic device such as an FPGA instead of or in addition to the CPU. CPU is an abbreviation of Central Processing Unit. FPGA is an abbreviation of Field-Programmable Gate Array.

The CPU or the like included in the processing device 12 executes the program 100, whereby the processing device 12 functions as the communication controller 120, the confusion detector 121, the determiner 122, the data manager 123, and the instructor 124 illustrated in FIG. 4.

The communication controller 120 controls the communication device 14 to acquire various kinds of information from a terminal device, an external storage device, an external server, and the like communicably connected to the server 1. The communication controller 120 causes the storage device 10 to store the acquired various kinds of information. The communication controller 120 controls the communication device 14 to transmit the various kinds of information to the terminal device, the external storage device, the external server, and the like. For example, the communication controller 120 acquires the operation information JMa from the smartphone 3a, which is a terminal device. The communication controller 120 acquires the operation information JMb from the smartphone 3b, which is a terminal device. The communication controller 120 transmits the instruction information JDa to the smartphone 3a.

The confusion detector 121 detects, based on the operation information JMa, a state in which the user Ua is confused about operation. That is, the confusion detector 121 determines, based on various kinds of information included in the operation information JMa, whether the user Ua is confused about operation. More specifically, the confusion detector 121 determines, based on the various kinds of information included in the operation information JMa, whether the user Ua is in a state in which the user Ua cannot determine on which item image among the plurality of item images GC included in the operation image GW the user Ua performs operation.

For example, the confusion detector 121 determines whether a time indicated by time information is equal to or larger than a threshold. When the time indicated by the time information is equal to or larger than the threshold, the confusion detector 121 determines that the user Ua is in the state in which the user Ua cannot determine on which item image among the plurality of item images GC included in the operation image GW the user Ua performs operation.

The confusion detector 121 determines whether the number of times of operation indicated by number of times information is equal to or larger than a threshold. When the number of times of operation indicated by the number of times information is equal to or larger than the threshold, the confusion detector 121 determines that the user Ua is in the state in which the user Ua cannot determine on which item image among the plurality of item images GC included in the operation image GW the user Ua performs operation.

The confusion detector 121 determines whether the same operation has been repeatedly executed for a plurality of times. When the same operation has been repeatedly executed for a plurality of times, for example, when operation for repeatedly pressing a specific item image GC, operation for repeatedly swiping the operation image GW up and down, or the like has been executed, the confusion detector 121 determines that the user Ua is in the state in which the user Ua cannot determine on which item image among the plurality of item images GC included in the operation image GW the user Ua performs operation.

A method of detecting a state in which the user Ua is confused about operation is not limited to the method explained above. Various methods can be adopted as the method.

The determiner 122 determines notification content for supporting operation by the user Ua. That is, the determiner 122 determines at least one item image GC to be a target on which the user Ua is urged to perform operation among the plurality of item images GC.

For example, the determiner 122 determines, based on the frequency information 103, as the item image GC to be a target on which the user Ua is urged to perform operation, the item image GC having the highest frequency of having been set as a target of operation performed by at least one of the user Ua and the user Ub. The item image GC having the highest frequency of having been set as a target of operation performed by at least one of the user Ua and the user Ub is sometimes referred to as “first priority item image”.

The determiner 122 determines, based on the frequency information 103, as the item image GC to be a target on which the user Ua is urged to perform operation, the item image GC having the second highest frequency of having been set as a target of operation performed by at least one of the user Ua and the user Ub next to the frequency of the first priority item image. The item image GC having the second highest frequency of having been set as a target of operation performed by at least one of the user Ua and the user Ub next to the frequency of the first priority item image is sometimes referred to as “second priority item image”.

When at least one item image GC to be a target on which the user Ua is urged to perform operation cannot be determined based on the frequency information 103, for example, when the number of the operation information JMa and the operation information JMb acquired by the server 1 is insufficient and reliability of an operation frequency indicated by the frequency information 103 is low, the determiner 122 determines, based on the designation information 101, the at least one item image GC to be a target on which the user Ua is urged to performed operation. That is, the determiner 122 determines, as the item images GC to be targets on which the user Ua is urged to perform operation, predetermined item images GC designated by the designation information 101.

When at least one item image GC to be a target on which the user Ua is urged to perform operation cannot be determined based on the designation information 101, for example, when the designation information 101 is not stored in the storage device 10 or when the predetermined item images GC designated by the designation information 101 are not included in the plurality of item images GC included in the operation image GW displayed on the touch panel 36a when operation was executed, the determiner 122 determines, based on the operation history information 102, the at least one item image GC to be a target on which the user Ua is urged to perform operation. Specifically, the determiner 122 determines, as the item image GC to be a target on which the user Ua is urged to perform operation, the item image GC indicated by the target information included in the operation history information 102.

In the following explanation, it is assumed that the first priority item image is the item image GC3, the item image GC4, the item image GC5, and the item image GC9 illustrated in FIGS. 2 and 3. That is, the item image GC3, the item image GC4, the item image GC5, and the item image GC9 are the item images GC having the highest frequency of having been set as a target of operation performed by at least one of the user Ua and the user Ub. Frequencies of having been set as the target of operation of the item image GC3, the item image GC4, the item image GC5, and the item image GC9 are equal.

It is assumed that the second priority item image is the item image GC2 illustrated in FIGS. 2 and 3. That is, the item image GC2 is the item image GC having the second highest frequency of having been set as a target of operation performed by at least one of the user Ua and the user Ub next to the frequency of the first priority item image.

It is assumed that the predetermined item images GC designated by the designation information 101 are the item image GC2, the item image GC3, the item image GC4, the item image GC5, and the item image GC9 illustrated in FIGS. 2 and 3.

The data manager 123 performs management of various kinds of information. For example, the data manager 123 updates the operation history information 102 based on the operation information JMa. Similarly, the data manager 123 updates the operation history information 102 based on the operation information JMb. Specifically, the data manager 123 updates the frequency information 103 based on target information included in the operation information JMa. The data manager 123 updates the frequency information 103 based on target information included in the operation information JMb. More specifically, the data manger 123 updates information indicating the number of times of operation performed on the item image GC indicated by the target information, the information being included in the frequency information 103.

The instructor 124 generates the instruction information JDa based on the notification content determined by the determiner 122. That is, the instructor 124 generates the instruction information JDa for causing the smartphone 3a to notify, to the user Ua, the at least one item image GC to be a target on which the user Ua is urged to perform operation, the at least one item image GC being determined by the determiner 122.

The communication device 14 includes, for example, an interface substrate including a connector and an interface circuit and has a function of receiving various kinds of information from a terminal device, an external storage device, an external server, and the like and a function of transmitting various kinds of information to the terminal device, the external storage device, the external server, and the like. The communication device 14 may transmit and receive the various kinds of information using wired communication or may transmit and receive the various kinds of information using wireless communication. When using the wireless communication, the communication device 14 includes an antenna adapted to wireless communication conforming to a predetermined communication standard. In this embodiment, the communication device 14 is communicably connected to the smartphone 3a and the smartphone 3b via the network NW and transmits and receives various kinds of information to and from the smartphone 3a and the smartphone 3b.

The touch panel 36a is a device obtained by integrating a display device that displays an image and an input device that receives input operation from the user Ua. The display device is a so-called display panel and includes, for example, a liquid crystal panel or an organic EL panel. EL is an abbreviation of Electro-Luminescence. The display device displays various images according to control by a control device (not illustrated) included in the smartphone 3a. The input device includes, for example, a transparent sheet-like contact sensor. The input device is provided to cover the display device. The input device detects a touch position using capacitance specified by an object that is in contact with the input device and the input device and outputs data indicating the detected touch position to the control device included in the smartphone 3a.

The touch panel 36b has the same configuration as the configuration of the touch panel 36a. A display device included in the touch panel 36b displays various images according to control by a control device (not illustrated) included in the smartphone 3b. An input device included in the touch panel 36b receives input operation from the user Ub and outputs data indicating a detected touch position to the control device included in the smartphone 3b.

The smartphone 3a generates the operation information JMa based on operation received from the user Ua in a state in which the smartphone 3a causes the touch panel 36a to display the operation image GW. The smartphone 3a transmits the operation information JMa to the server 1.

The smartphone 3b generates the operation information JMb based on operation received from the user Ub in a state in which the smartphone 3b causes the touch panel 36b to display the operation image GW. The smartphone 3b transmits the operation information JMb to the server 1.

### 1.3. Operation of the Server

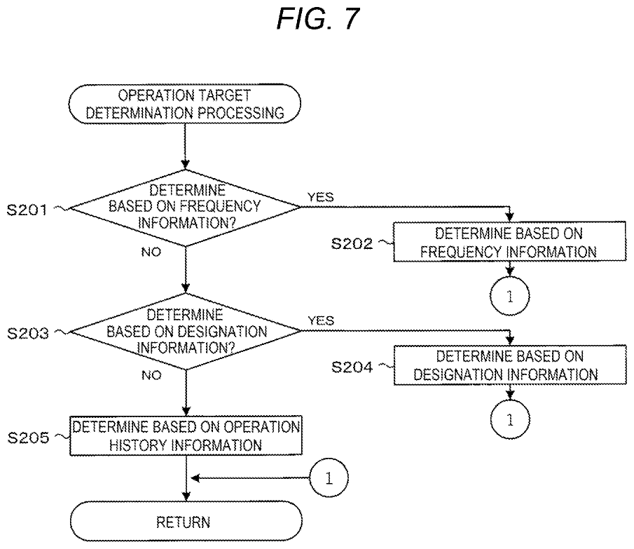

An operation of the server 1 according to the first embodiment is explained with reference to FIGS. 6 and 7.

FIG. 6 is a flowchart for explaining the operation of the server 1 according to the first embodiment. A series of operation illustrated in the flowchart is started, for example, when the server 1 receives the operation information JMa from the smartphone 3a in a state in which the server 1 is on.

In step S101, the communication controller 120 controls the communication device 14 to acquire the operation information JMa from the smartphone 3a.

In step S102, the confusion detector 121 determines, based on the operation information JMa, whether the user Ua is confused about operation. That is, the confusion detector 121 determines, based on the operation information JMa, whether the user Ua is in a state in which the user Ua cannot determine on which item image among the plurality of item images GC included in the operation image GW the user Ua performs operation. When the user Ua is confused about operation, in other words, when the user Ua is in the state in which the user Ua cannot determine on which item image among the plurality of item images GC included in the operation image GW the user Ua performs operation, that is, in the case of YES in step S102, the confusion detector 121 advances the processing to step S200. When the user Ua is not confused about operation, in other words, when the user Ua is not in the state in which the user Ua cannot determine on which item image among the plurality of item images GC included in the operation image GW the user Ua performs operation, that is, in the case of NO in step S102, the confusion detector 121 advances the processing to step S105.

When determining, based on the operation information JMa, that the user Ua is in the state in which the user Ua cannot determine on which item image among the plurality of item images GC included in the operation image GW the user Ua performs operation, in other words, when detecting the state in which the user Ua cannot determine on which item image among the plurality of item images GC included in the operation image GW the user Ua performs operation, in step S200, the processing device 12 determines notification content for supporting operation by the user Ua. That is, the processing device 12 determines, with operation target determination processing executed in step S200, at least one item image GC to be a target on which the user Ua is urged to perform operation among the plurality of item images GC. When the processing in step S200 is executed, the processing device 12 advances the processing to step S103.

FIG. 7 is a flowchart for explaining the operation target determination processing. The flowchart illustrates a series of operation in the operation target determination processing in step S200.

In step S201, the determiner 122 determines whether at least one item image GC to be a target on which the user Ua is urged to perform operation can be determined based on the frequency information 103. When at least one item image GC to be a target on which the user Ua is urged to perform operation can be determined based on the frequency information 103, that is, in the case of YES in step S201, the determiner 122 advances the processing to step S202. When at least one item image GC to be a target on which the user Ua is urged to perform operation cannot be determined based on the frequency information 103, that is, in the case of NO in step S201, the determiner 122 advances the processing to step S203.

In step S202, the determiner 122 determines, based on the frequency information 103, at least one item image GC to be a target on which the user Ua is urged to perform operation among the plurality of item images GC. Specifically, the determiner 122 determines first priority item images and second priority item images as the item images GC to be targets on which the user Ua is urged to perform operation. More specifically, the determiner 122 determines the item image GC2, the item image GC3, the item image GC4, the item image GC5, and the item image GC9 as the item images GC to be targets on which the user Ua is urged to perform operation.

In step S203, the determiner 122 determines whether at least one item image GC to be a target on which the user Ua is urged to perform operation can be determined based on the designation information 101. When at least one item image GC to be a target on which the user Ua is urged to perform operation can be determined based on the designation information 101, that is, in the case of YES in step S203, the determiner 122 advances the processing to step S204. When at least one item image GC to be a target on which the user Ua is urged to perform operation cannot be determined based on the designation information 101, that is, in the case of NO in step S203, the determiner 122 advances the processing to step S205.

In step S204, the determiner 122 determines, based on the designation information 101, at least one item image GC to be a target on which the user Ua is urged to perform operation among the plurality of item images GC. Specifically, the determiner 122 determines predetermined item images GC designated by the designation information 101 as the item images GC to be targets on which the user Ua is urged to perform operation. More specifically, the determiner 122 determines the item image GC2, the item image GC3, the item image GC4, the item image GC5, and the item image GC9 as the item images GC to be targets on which the user Ua is urged to perform operation.

In step S205, the determiner 122 determines, based on the operation history information 102, at least one item image GC to be a target on which the user Ua is urged to perform operation among the plurality of item images GC. Specifically, the determiner 122 determines the item image GC indicated by the target information included in the operation history information 102 as the item image GC to be a target on which the user Ua is urged to perform operation.

After the processing in step S202, step S204, or step S205 is executed, the processing device 12 terminates the operation target determination processing illustrated in the flowchart of FIG. 7.

When terminating the operation target determination processing illustrated in the flowchart of FIG. 7, the processing device 12 executes the processing in step S103 illustrated in the flowchart of FIG. 6.

In step S103, the instructor 124 generates the instruction information JDa based on the notification content determined by the determiner 122.

For example, when the determiner 122 determines, based on the frequency information 103, at least one item image GC to be a target on which the user Ua is urged to perform operation, the instruction information JDa is information for causing the smartphone 3a to notify the user Ua that the at least one item image GC is the item image GC2, the item image GC3, the item image GC4, the item image GC5, and the item image GC9.

In step S104, the communication controller 120 controls the communication device 14 to transmit the instruction information JDa to the smartphone 3a.

The smartphone 3a notifies the notification content determined by the determiner 122 to the user Ua based on the instruction information JDa. Specifically, the smartphone 3a causes, based on the instruction information JDa, the touch panel 36a to display an image for notifying, to the user Ua, the at least one item image GC to be a target on which the user Ua is urged to perform operation.

In step S105, the data manager 123 updates the operation history information 102 based on the operation information JMa. Specifically, the data manager 123 updates the frequency information 103 based on the target information included in the operation information JMa.

After the processing in step S105 is executed, the processing device 12 terminates the series of operation illustrated in the flowchart of FIG. 6.

Consequently, according to the first embodiment, the server 1 can determine, based on the operation history information 102, at least one item image GC to be a target on which the user Ua is urged to perform operation among the plurality of item images GC. That is, the server 1 can set, as the item images GC to be targets on which the user Ua is urged to perform operation, the item images GC on which operation by at least one of the user Ua and the user Ub has actually been performed.

According to the first embodiment, the server 1 can determine, based on the frequency information 103, the first priority item images and the second priority item images as the item images GC to be targets on which the user

Ua is urged to perform operation. That is, the server 1 can select the item images GC having high operation frequencies out of the item images GC on which operation by at least one of the user Ua and the user Ub has actually been performed and set the item images GC as the item images GC to be targets on which the user Ua is urged to perform operation.

According to the first embodiment, the server 1 can determine, based on the designation information 101, predetermined item images GC as the item images GC to be targets on which the user Ua is urged to perform operation. That is, even when at least one item image GC to be a target on which the user Ua is urged to perform operation cannot be determined based on the frequency information 103, for example, the server 1 can perform highly accurate operation support by setting, as the item image GC to be designated by the designation information 101, the item image GC predicted in advance to have a high operation frequency.

As explained above, the image determination method according to the first embodiment includes acquiring the operation information JMa concerning operation by the user Ua in a state in which the operation image GW including the plurality of item images GC is displayed and, when detecting, based on the operation information JMa, a state in which the user Ua cannot determine on which item image GC among the plurality of item images GC the user Ua performs operation, based on the operation history information 102 concerning the item image GC set as a target of operation performed by at least one of the user Ua and the user Ub different from the user Ua in the state in which the operation image GW is displayed, determining at least one item image GC to be a target on which the user Ua is urged to perform operation among the plurality of item images GC.

The server 1 according to the first embodiment includes the processing device 12, the processing device 12 executing acquiring the operation information JMa concerning operation by the user Ua in a state in which the operation image GW including the plurality of item images GC is displayed and, when detecting, based on the operation information JMa, a state in which the user Ua cannot determine on which item image GC among the plurality of item images GC the user Ua performs operation, based on the operation history information 102 concerning the item image GC set as a target of operation performed by at least one of the user Ua and the user Ub different from the user Ua in the state in which the operation image GW is displayed, determining at least one item image GC to be a target on which the user Ua is urged to perform operation among the plurality of item images GC.

The program 100 according to the first embodiment causes the processing device 12 to execute acquiring the operation information JMa concerning operation by the user Ua in a state in which the operation image GW including the plurality of item images GC is displayed and, when detecting, based on the operation information JMa, a state in which the user Ua cannot determine on which item image GC among the plurality of item images GC the user Ua performs operation, based on the operation history information 102 concerning the item image GC set as a target of operation performed by at least one of the user Ua and the user Ub different from the user Ua in the state in which the operation image GW is displayed, determining at least one item image GC to be a target on which the user Ua is urged to perform operation among the plurality of item images GC.

That is, the server 1 sets, as item image GC to be a target on which the user Ua is urged to perform operation, the item image GC on which operation by at least one of the user Ua and the user Ub has actually been performed. Consequently, the user Ua becomes capable of grasping an operation method and can eliminate confusion.

In the first embodiment, the item image GC is an example of the “item image”, the operation image GW is an example of the “image including a plurality of item images”, the user Ua is an example of the “first user”, the user Ub is an example of the “second user”, the operation information JMa is an example of the “operation information concerning operation by the first user”, the operation history information 102 is an example of the “operation history information”, the server 1 is an example of the “information processing apparatus”, the processing device 12 is an example of the “processing device”, and the program 100 is an example of the “program”.

In the image determination method according to the first embodiment, the operation history information 102 includes the frequency information 103 indicating frequencies of operation for the respective plurality of item images GC by at least one of the user Ua and the user Ub, the determining at least one item image GC includes determining at least one first priority item image based on the frequency information 103, and the at least one first priority item image is the item image GC having the highest frequency of having been set as operation performed by at least one of the user Ua and the user Ub.

That is, the server 1 selects the item image GC having the highest operation frequency out of the item images GC on which operation by at least one of the user Ua and the user Ub has actually been performed and sets the item image GC as the item image GC to be a target on which the user Ua is urged to perform operation. Consequently, the user Ua becomes capable of grasping a highly reliable operation method and can surely eliminate confusion.

In the first embodiment, the frequency information 103 is an example of the “frequency information”. The item image GC3, the item image GC4, the item image GC5,

In the image determination method according to the first embodiment, the determining the at least one item image GC includes determining at least one second priority item image based on the frequency information 103 and the at least one second priority item image is the item image GC having the second highest frequency of having been set as a target of operation performed by at least one of the user Ua and the user Ub next to the at least one first priority item image.

That is, while selecting the item image GC having a high operation frequency out of the item images GC on which operation by at least one of the user Ua and the user Ub has actually been performed, the server 1 can increase choices of the item image GC to be a target on which the user Ua is urged to perform operation. Consequently, the user Ua becomes capable of grasping a highly reliable plurality of operation methods and can more surely eliminate confusion.

In the first embodiment, the item image GC2 is an example of the “at least one second priority item image”.

The image determination method according to the first embodiment further includes, when at least one item image GC cannot be determined based on the frequency information 103 indicating frequencies of operation for the respective plurality of item images GC by at least one of the user Ua and the user Ub, determining the at least one item image GC based on the designation information 101 for designating predetermined item images GC among the plurality of item images GC.

Consequently, even when at least one item image GC to be a target on which the user Ua is urged to perform operation cannot be determined based on the frequency information 103, the server 1 can perform highly accurate operation support by, for example, setting, as the item image GC designated by the designation information 101, the item image GC predicted to have a high operation frequency.

In the first embodiment, the designation information 101 is an example of the “designation information”. The item image GC2, the item image GC3, the item image GC4, the item image GC5, and the item image GC9 are examples of the “predetermined item image”.

In the image determination method according to the first embodiment, a display form of the operation image GW displayed to the user Ua and a display form of the operation image GW displayed to the user Ub are different and the determining the at least one item image GC includes determining, based on the frequency information 103 indicating frequencies of operation for the respective plurality of item images GC in the display form of the operation image GW displayed to the user Ua, at least one item image GC to be a target on which the user Ua is urged to perform operation.

For example, when the operation image GW is a GUI used in operating specific application software, in some case, a version of the application software is updated and a display form of the operation image GW displayed on terminals of a part of users changes. Even in such a case, the server 1 determines, based on the frequency information 103 based on operation information acquired from the terminals of the users, the item image GC to be a target on which the user Ua is urged to perform operation. That is, the server 1 becomes capable of acquiring operation information from a wide range of users. Reliability of a frequency indicated by the frequency information 103 is improved. Consequently, the user Ua becomes capable of grasping a highly reliable operation method and can more surely eliminate confusion compared with when operation information is acquired only from a terminal on which the operation image GW having the same display form as the display form of the operation image GW displayed to the user Ua is displayed.

### 2. Second Embodiment

A second embodiment of the present disclosure is explained below. In embodiments illustrated below, components having the same action and functions as those in the first embodiment are denoted by the same reference numerals and signs as those used in the first embodiment and detailed explanation of the respective components is omitted.

In the second embodiment, the image determination method, the information processing apparatus, and the program according to the present disclosure are explained by illustrating a smartphone that, when detecting a state in which a user is confused about operation, determines, based on an operation history of the user, notification content for supporting the operation.

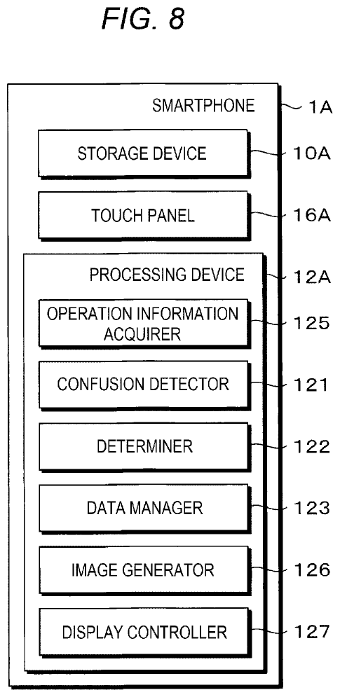

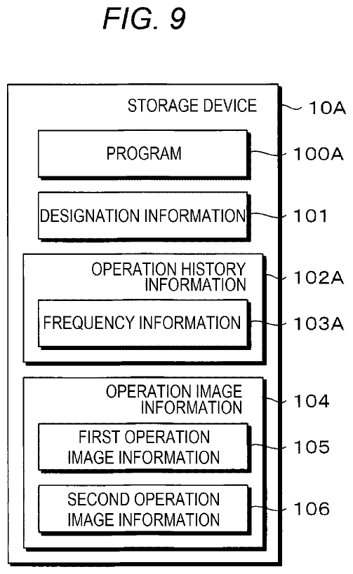

A configuration and functions of a smartphone 1A according to the second embodiment are explained below with reference to FIGS. 8 and 9. FIG. 8 is a block diagram illustrating a configuration of the smartphone 1A according to the second embodiment. FIG. 9 is a block diagram illustrating a configuration of a storage device 10A according to the second embodiment.

The smartphone 1A is different from the server 1 according to the first embodiment in that the smartphone 1A includes a storage device 10A instead of the storage device 10, includes a processing device 12A instead of the processing device 12, and includes a touch panel 16A. The processing device 12A is different from the processing device 12 in that the processing device 12A has a function of an operation information acquirer 125, has a function of an image generator 126 instead of the instructor 124, and has a function of a display controller 127.

The storage device 10A is different from the storage device 10 in that the storage device 10A stores a program 100A instead of the program 100, stores operation history information 102A instead of the operation history information 102, and stores operation image information 104. The operation history information 102A is different from the operation history information 102 in that the operation history information 102A includes frequency information 103A instead of the frequency information 103. The operation history information 102A is information concerning the item image GC set as a target of operation of a user of the smartphone 1A in a state in which the operation image GW is displayed. The frequency information 103A is information indicating frequencies of operation for the respective plurality of item images GC by the user of the smartphone 1A. The operation image information 104 is information representing the operation image GW. The operation image information 104 includes first operation image information 105 and second operation image information 106. The first operation image information 105 is information representing the operation image GWa1. The second operation image information 106 is information representing an image obtained by superimposing, on the operation image GWa1, an image for supporting operation by the user of the smartphone 1A.

In this embodiment, the item image GC having the highest frequency of having been set as a target of operation by the user of the smartphone 1A is sometimes referred to as “first priority item image”. The item image GC having the second highest frequency of having been set as a target of operation by the user of the smartphone 1A next to the first priority item image is sometimes referred to as “second priority item image”.

A CPU or the like included in the processing device 12A executes the program 100A, whereby the processing device 12A functions as the operation information acquirer 125, the confusion detector 121, the determiner 122, the data manager 123, the image generator 126, and the display controller 127.

The touch panel 16A has the same configuration as the configuration of the touch panel 36a and the touch panel 36b. A display device included in the touch panel 16A displays various images according to control by the display controller 127. An input device included in the touch panel 16A receives input operation from the user of the smartphone 1A and outputs data indicating a detected touch position to the processing device 12A.

The display controller 127 controls the touch panel 16A to display various images. For example, the display controller 127 causes, based on the operation image information 104, the touch panel 16A to display the operation image GW. Specifically, the display controller 127 causes, based on the first operation image information 105, the touch panel 16A to display the operation image GWa1.

When the touch panel 16A receives operation from the user, the operation information acquirer 125 acquires data concerning the operation from the touch panel 16A. The data includes information indicating a position on the touch panel 16A where the operation is received. That is, the operation information acquirer 125 acquires operation information from the touch panel 16A. The operation information acquirer 125 imparts, to the acquired operation information, various kinds of information concerning operation executed on the smartphone 1A by the user such as information indicating the operation image GW displayed on the touch panel 16A when operation was executed, target information, number of times information, and time information. Therefore, the operation information to which the various kinds of information are imparted includes the same information as the information included in the operation information JMa and the operation information JMb.

The image generator 126 generates a notification image GN based on notification content determined by the determiner 122. The notification image GN is an image for supporting operation by the user. Specifically, the notification image GN is an image for notifying the notification content determined by the determiner 122 to the user. More specifically, the notification image GN is an image for notifying, to the user, at least one item image GC to be a target on which the user is urged to perform operation, the at least one item image being determined by the determiner 122.

The image generator 126 superimposes the notification image GN on the operation image GW. For example, the image generator 126 superimposes the notification image GN on the operation image GWa1. In other words, the image generator 126 edits the operation image GWa1 based on the notification content determined by the determiner 122. Further, in other words, the image generator 126 generates the second operation image information 106 based on the first operation image information 105 representing the operation image GWa1 and the notification content determined by the determiner 122. That is, the second operation image information 106 is information representing an image obtained by superimposing the notification image GN on the operation image GWa1.

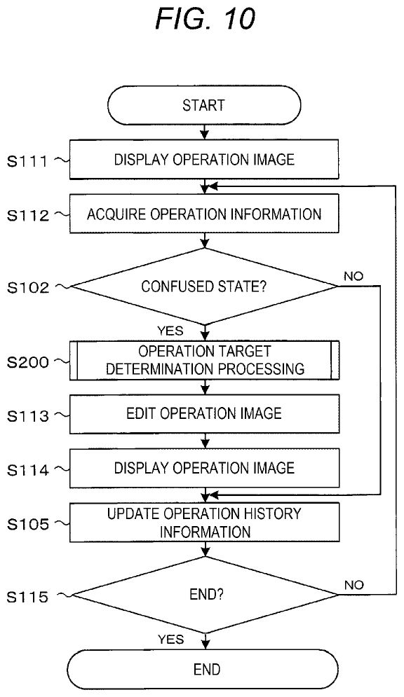

FIG. 10 is a flowchart for explaining an operation of the smartphone 1A according to the second embodiment. The flowchart of FIG. 10 is the same as the flowchart of FIG. 6 except that processing in step S111 and step S112 is executed instead of the processing in step S101, processing in step S113 is executed instead of the processing in step S103, processing in step S114 is executed instead of the processing in step S104, and processing in step S115 is executed.

In step S111, the display controller 127 causes, based on the first operation image information 105, the touch panel 16A to display the operation image GWa1.

In step S112, the operation information acquirer 125 acquires operation information from the touch panel 16A. The operation information acquirer 125 imparts various kinds of information to the acquired operation information.

In step S113, the image generator 126 edits the operation image GWa1 based on the notification content determined by the determiner 122. That is, the image generator 126 generates the notification image GN based on the notification content determined by the determiner 122. The image generator 126 superimposes the notification image GN on the operation image GWa1.

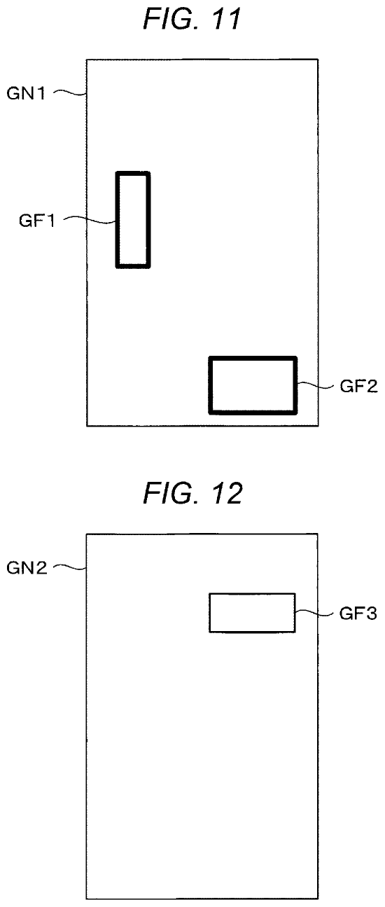

FIG. 11 is a schematic diagram for explaining a notification image GN1. FIG. 12 is a schematic diagram for explaining a notification image GN2. The notification image GN1 and the notification image GN2 are examples of the notification image GN. The notification image GN1 and the notification image GN2 are generated in step S113 in the case of YES in step S201 illustrated in the flowchart of FIG. 7.

The notification image GN1 is an image for notifying, to the user, the first priority item image determined in step 5202 as the item image GC to be a target on which the user is urged to perform operation. The notification image GN1 includes an instruction image GF1 and an instruction image GF2. The instruction image GF1 is an image for instructing the item image GC3, the item image GC4, and the item image GC5. The instruction image GF2 is an image for instructing the item image GC9.

The notification image GN2 is an image for notifying, to the user, the second priority item image determined in step S202 as the item image GC to be a target on which the user is urged to perform operation. The notification image GN2 includes an instruction image GF3. The instruction image GF3 is an image for instructing the item image GC2.

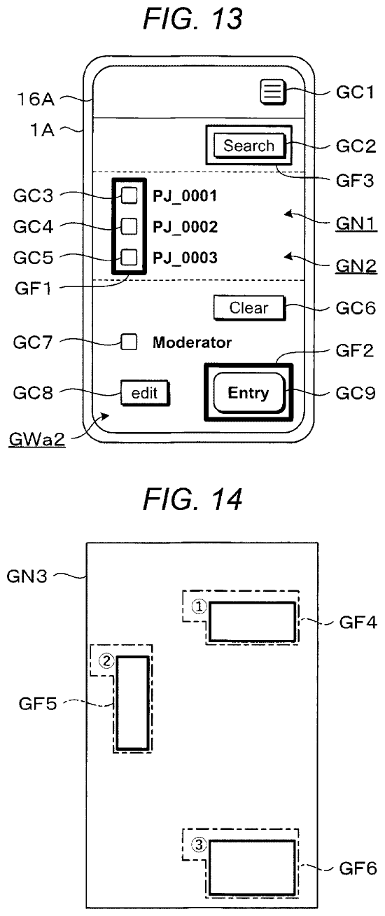

FIG. 13 is a schematic diagram for explaining an operation image GWa2. The operation image GWa2 is an image obtained by superimposing the notification image GN1 and the notification image GN2 on the operation image GWa1. The operation image GWa2 is sometimes displayed on the touch panel 16A in step S114 explained below. As illustrated in FIG. 13, the first priority item images are instructed by the instruction image GF1 and the instruction image GF2. The second priority item image is instructed by the instruction image GF3. That is, the user becomes capable of grasping an operation method and can eliminate confusion by checking the item image GC notified by the notification image GN1 and the notification image GN2.

Display forms of the notification image GN1 and the notification image GN2 may be different from each other. For example, a frame line shown as the instruction image GF1 and a frame line shown as the instruction image GF2 are thicker than a frame line shown as the instruction image GF3. That is, the user can grasp, from the difference between the display forms of the notification image GN1 and the notification image GN2, a magnitude relation between an operation frequency of the item image GC instructed by the notification image GN1 and an operation frequency of the item image GC instructed by the notification image GN2.

FIG. 14 is a schematic diagram for explaining a notification image GN3. The notification image GN3 is an example of the notification image GN. The notification image GN3 is generated in step S113 in the case of YES in step S203 illustrated in the flowchart of FIG. 7.

The notification image GN3 is an image for notifying, to the user, the predetermined item images GC designated by the designation information 101 determined as the item image GC to be a target on which the user is urged to perform operation. The notification image GN3 includes an instruction image GF4, an instruction image GF5, and an instruction image GF6. The instruction image GF4 is an image for instructing the item image GC2. The instruction image GF5 is an image for instructing the item image GC3, the item image GC4, and the item image GC5. The instruction image GF6 is an image for instructing the item image GC9.

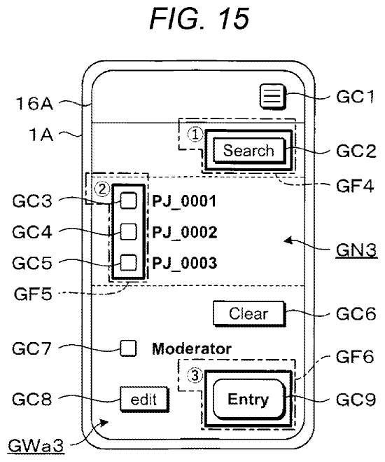

FIG. 15 is a schematic diagram for explaining an operation image GWa3. The operation image GWa3 is an image obtained by superimposing the notification image GN3 on the operation image GWa1. The operation image GWa3 is sometimes displayed on the touch panel 16A in step S114 explained below. As illustrated in FIG. 15, the predetermined item images GC designated by the designation information 101 are instructed by the instruction image GF4, the instruction image GF5, and the instruction image GF6. That is, the user becomes capable of grasping an operation method and can eliminate confusion by checking the item image GC notified by the notification image GN3.

The instruction images GF4 to GF6 included in the notification image GN3 may respectively include numbers for showing operation order to the user. For example, the instruction image GF4 includes “1” indicating a first operation target. The instruction image GF5 includes “2” indicating a second operation target. The instruction image GF6 includes “3” indicating a third operation target. That is, the user can grasp the operation order by checking the numbers respectively included in the instruction images GF4 to GF6. Consequently, the user can accomplish a series of operation by pressing, in the order of the numbers respectively included in the instruction images GF4 to GF6, the item images GC respectively instructed by the instruction images GF4 to GF6.

In step S114, the display controller 127 causes, based on the second operation image information 106, the touch panel 16A to display an image obtained by superimposing the notification image GN on the operation image GWa1. For example, the display controller 127 causes the touch panel 16A to display the operation image GWa2 or the operation image GWa3.

In step S115, the data manager 123 determines, based on operation information, whether operation concerning an operation end is performed by the user. When the operation concerning the operation end is performed by the user, that is, in the case of YES in step S115, the processing device 12A including the data manager 123 terminates a series of operation illustrated in the flowchart of FIG. 10. When the operation concerning the operation end is not performed by the user, that is, in the case of NO in step S115, the data manager 123 advances the processing to step S112.

For example, when the pressed item image GC is a button for instructing the smartphone 1A to end operation or a button for instructing the smartphone 1A to transition the operation image GW displayed on the touch panel 16A to another operation image GW, the processing device 12 terminates the series of operation illustrated in the flowchart of FIG. 10.

Consequently, according to the second embodiment, the smartphone 1A can determine, based on the frequency information 103A, the first priority item image and the second priority item image as the item images GC to be targets on which the user is urged to perform operation. The smartphone 1A can cause the touch panel 16A to display the notification image GN1 for notifying the first priority item image to the user and the notification image GN2 for notifying the second priority item image to the user. That is, the smartphone 1A can notify an item determined to support operation by the user with a simpler configuration compared with the first embodiment.

As explained above, the image determination method according to the second embodiment further includes causing the touch panel 16A to display the notification image GN1 for notifying at least one first priority item image to the user of the smartphone 1A and the notification image GN2 for notifying at least one second priority item image to the user of the smartphone 1A.

That is, the smartphone 1A according to this embodiment visually notifies, to the user, the item image GC to be a target on which the user is urged to perform operation. Consequently, the user can easily grasp, for example, which item image GC the item image GC to be a target is and where the item image GC to be a target is present.

In the second embodiment, the user of the smartphone 1A is an example of the “first user”, the notification image GN1 is an example of the “first notification image”, the notification image GN2 is an example of the “second notification image”, and the touch panel 16A is an example of the “display device”. The item image GC3, the item image GC4, the item image GCS, and the item image GC9 are examples of the “at least one first priority item image”. The item image GC2 is an example of the “at least one second priority item image”.

### 3. Modifications

The embodiments explained above can be variously modified. Specific aspects of modifications are illustrated below. Two or more aspects optionally selected from the following illustration can be combined as appropriate in a range in which the aspects do not contradict. In modifications illustrated below, components, action and functions of which are equivalent to those in the embodiments explained above, are denoted by the reference numerals and signs used in the above explanation and detailed explanation of the components is omitted as appropriate.

### 3.1. Modification 1

In the embodiments explained above, a case is illustrated in which a determined notification content is notified using an image. However, the present disclosure is not limited to such an aspect. For example, the determined notification content may be notified using voice. When notification is performed using voice, a notification image is not superimposed on an operation image. Therefore, for example, even when the area of an image display portion in a display device is small, it is possible to perform the notification without deteriorating visibility of the operation image.

### 3.2. Modification 2

In the embodiments and the modification explained above, the server 1 and the smartphone 1A are illustrated as the information processing apparatus according to the present disclosure. However, the present disclosure is not limited to such an aspect. For example, a personal computer having the same function as the function of the smartphone 1A may be used.

When the personal computer is used, it is assumed that a pointer for pressing the item image GC is displayed on a display device included in the personal computer or a display device connected to the personal computer. In such a case, it may be determined, using information concerning a coordinate of the pointer, whether the user is confused about operation. Specifically, when the coordinate of the pointer repeatedly moves back and forth between specific two regions, it may be determined that the user is confused about operation. That is, by setting an appropriate determination method according to an apparatus that implements the present disclosure, it is possible to accurately detect a state in which the user is confused about operation.

### 3.3. Modification 3

In the embodiments and the modifications explained above, a case is illustrated in which at least one item image GC to be a target on which the user is urged to perform operation is determined based on frequency information indicating frequencies of operation for the respective plurality of item images GC of the one or the plurality of users. However, the present disclosure is not limited to such an aspect. For example, at least one item image GC to be a target on which the user is urged to perform operation may be determined based on success frequency information indicating a frequency of operation satisfying a predetermined condition among kinds of operation for the respective plurality of item images GC of the one or the plurality of users. The success frequency information indicates, for example, a frequency of the one or the plurality of users having pressed predetermined item images GC among the plurality of item images GC or a frequency of the one or the plurality of users having pressed the predetermined item images GC in predetermined order. In step S201 of the operation target determination processing, the determiner 122 may determine whether at least one item image GC to be a target on which the user is urged to perform operation can be determined based on the success frequency information. Consequently, it becomes possible to limit, in advance, the item images GC likely to be notified to the user and perform highly accurate notification.

### 3.4. Modification 4

In the embodiments and the modifications explained above, a case is illustrated in which, when at least one item image GC to be a target on which the user is urged to perform operation is determined based on the frequency information, the first priority item image and the second priority item image are determined as the item images GC to be targets on which the user is urged to perform operation. However, the present disclosure is not limited to such an aspect. For example, only the first priority item image may be determined as the item image GC to be a target on which the user is urged to perform operation. When the item image GC having the third highest frequency of having being set as a target of operation performed by the one or the plurality of users next to the second priority item image is referred to as “third priority item image”, the first priority item image, the second priority item image, and the third priority item image may be determined as the item images GC to be targets on which the user is urged to perform operation.

Instruction images for instructing the first priority item image, the second priority item image, and the third priority item image may include numbers for showing a magnitude relation among frequencies to the user like the instruction images for instructing the predetermined item images GC designated by the designation information 101. That is, the user can grasp a priority level of operation by checking numbers included in a respective plurality of instruction images.

### 3.5. Modification 5

In the embodiments and the modifications explained above, a case is illustrated in which the smartphone 1A determines, based on the operation history information 102A, at least one item image GC to be a target on which the user is urged to perform operation. However, the present disclosure is not limited to such an aspect. For example, the smartphone 1A may acquire operation history information from a server that collects operation information from a plurality of users and determine, based on the operation history information, at least one item image GC to be a target on which the user is urged to perform operation. That is, the smartphone 1A may determine, based on information concerning the item images GC set as targets of operation of the plurality of users, at least one item image GC to be a target on which the user is urged to perform operation.

### 4. Notes

A summary of the present disclosure is described below as notes.

### 4.1. Note 1

An image determination method including: acquiring operation information concerning operation by a first user in a state in which an image including a plurality of item images is displayed; and, when detecting, based on the operation information, a state in which the first user cannot determine on which item image among the plurality of item images the first user performs operation, determining, based on operation history information concerning an item image set as a target of operation performed by at least one of the first user and a second user different from the first user in the state in which the image including the plurality of item images is displayed, at least one item image to be a target on which the first user is urged to perform operation among the plurality of item images.

That is, an information processing apparatus that realizes the image determination method described in Note 1 sets, as the item image to be a target on which the first user is urged to perform operation, an item image on which operation by at least one of the first user and the second user has actually been performed. Consequently, the first user becomes capable of grasping an operation method and can eliminate confusion.

### 4.2. Note 2

The image determination method descried in Note 1, wherein the operation history information includes frequency information indicating frequencies of operation for the respective plurality of item images by at least one of the first user and the second user, the determining the at least one item image includes determining at least one first priority item image based on the frequency information, and the at least one first priority item image is an item image having a highest frequency of having been set as a target of the operation performed by at least one of the first user and the second user.

That is, the information processing apparatus that realizes the image determination method described in Note 2 selects an item image having the highest operation frequency out of item images on which operation by at least one of the first user and the second user has actually been performed and sets the item image as the item image to be a target on which the first user is urged to perform operation. Consequently, the first user becomes capable of grasping a highly reliable operation method and can surely eliminate confusion.

### 4.3. Note 3

The image determination method described in Note 2, wherein the determining the at least one item image includes determining at least one second priority item image based on the frequency information, and the at least one second priority item image is an item image having a second highest frequency of having been set as a target of operation performed by at least one of the first user and the second user next to the at least one first priority item image.

That is, while selecting an item image having a high operation frequency out of the item images on which operation by at least one of the first user and the second user has actually been performed, the information processing apparatus that realizes the image determination method described in Note 3 can increase choices of the item image to be a target on which the first user is urged to perform operation. Consequently, the first user becomes capable of grasping a highly reliable plurality of operation methods and can more surely eliminate confusion.

### 4.4. Note 4

The image determination method described in Note 3, further including causing a display device to display a first notification image for notifying the at least one first priority item image to the first user and a second notification image for notifying the at least one second priority item image to the first user.

That is, the information processing apparatus that realizes the image determination method described in Note 4 visually notifies, to the first user, the item image to be a target on which the first user is urged to perform operation. Consequently, the first user can easily grasp, for example, which item image the item image to be a target is and where the item image to be a target is present.

### 4.5. Note 5

The image determination method described in any one of Note 1 to Note 4, further including, when the at least one item image cannot be determined based on frequency information indicating frequencies of operation for the respective plurality of item images by at least one of the first user and the second user, determining the at least one item image based on designation information for designating a predetermined item image among the plurality of item images.

Consequently, even when at least one item image to be a target on which the first user is urged to perform operation cannot be determined based on the frequency information, the information processing apparatus that realizes the image determination method described in Note 5 can perform highly accurate operation support by, for example, setting, as the item image designated by the designation information, an item image predicted in advance to have a high operation frequency.

### 4.6. Note 6

The image determination method according to any one of Note 1 to Note 5, wherein a display form of an image including the plurality of item images displayed to the first user and a display form of an image including the plurality of item images displayed to the second user are different, and the determining the at least one item image includes determining, based on frequency information indicating frequencies of operation for the respective plurality of item images in the display form of the image including the plurality of item images displayed to the first user, the at least one item image to be a target on which the first user is urged to perform operation.

For example, when the image including the plurality of item images is a GUI used in operating specific application software, in some case, a version of the application software is updated and a display form of the image including the plurality of item images displayed on terminals of a part of users changes. Even in such a case, the information processing apparatus that realizes the image determination method described in Note 6 determines, based on frequency information based on operation information acquired from the terminals of the users, an item image to be a target on which the first user is urged to perform operation. That is, the information processing apparatus that realizes the image determination method described in Note 6 becomes capable of acquiring operation information from a wide range of users. Reliability of a frequency indicated by the frequency information is improved. Consequently, the first user becomes capable of grasping a highly reliable operation method and can more surely eliminate confusion compared with when operation information is acquired only from a terminal on which an image including a plurality of item images having the same display form as the display form of the image including the plurality of item images displayed to the first user is displayed.

### 4.7. Note 7

An information processing apparatus including a processing device, the processing device executing: acquiring operation information concerning operation by a first user in a state in which an image including a plurality of item images is displayed; and, when detecting, based on the operation information, a state in which the first user cannot determine on which item image among the plurality of item images the first user performs operation, determining, based on operation history information concerning an item image set as a target of operation performed by at least one of the first user and a second user different from the first user in the state in which the image including the plurality of item images is displayed, at least one item image to be a target on which the first user is urged to perform operation among the plurality of item images.

That is, the information processing apparatus described in Note 7 sets, as the item image to be a target on which the first user is urged to perform operation, an item image on which operation by at least one of the first user and the second user has actually been performed. Consequently, the first user becomes capable of grasping an operation method and can eliminate confusion.

### 4.8. Note 8

A non-transitory computer-readable storage medium storing a program, the program causing a processing device to execute: acquiring operation information concerning operation by a first user in a state in which an image including a plurality of item images is displayed; and, when detecting, based on the operation information, a state in which the first user cannot determine on which item image among the plurality of item images the first user performs operation, determining, based on operation history information concerning an item image set as a target of operation performed by at least one of the first user and a second user different from the first user in the state in which the image including the plurality of item images is displayed, at least one item image to be a target on which the first user is urged to perform operation among the plurality of item images.

That is, an information processing apparatus that executes the program stored in the non-transitory computer-readable storage medium described in Note 8 sets, as the item image to be a target on which the first user is urged to perform operation, an item image on which operation by at least one of the first user and the second user has actually been performed. Consequently, the first user becomes capable of grasping an operation method and can eliminate confusion.

What is claimed is:

1. An image determination method comprising:
acquiring operation information concerning operation by a first user in a state in which an image including a plurality of item images is displayed; and
when detecting, based on the operation information, a state in which the first user cannot determine on which item image among the plurality of item images the first user performs operation, determining, based on operation history information, at least one item image to be recommended as a target on which the first user perform operation among the plurality of item images, the operation history information being information concerning an item image which has been a target of operation performed by at least one of the first user and a second user different from the first user in the state in which the image including the plurality of item images is displayed.

2. The image determination method according to claim 1, wherein
the operation history information includes frequency information indicating frequencies of operation for the respective plurality of item images by at least one of the first user and the second user,
the determining the at least one item image includes determining at least one first priority item image based on the frequency information, and
the at least one first priority item image is at least one item image having a highest frequency of having been a target of the operation performed by at least one of the first user and the second user.

3. The image determination method according to claim 2, wherein
the determining the at least one item image includes determining at least one second priority item image based on the frequency information, and
the at least one second priority item image is at least one item image having a second highest frequency of having been a target of operation performed by at least one of the first user and the second user next to the at least one first priority item image.

4. The image determination method according to claim 3, further comprising causing a display device to display a first notification image for notifying the at least one first priority item image to the first user and a second notification image for notifying the at least one second priority item image to the first user.

5. The image determination method according to claim 1, further comprising, when the at least one item image cannot be determined based on frequency information indicating frequencies of operation for the respective plurality of item images by at least one of the first user and the second user, determining the at least one item image based on designation information for designating a predetermined item image among the plurality of item images.

6. The image determination method according to claim 1, wherein a display form of an image including the plurality of item images displayed to the first user and a display form of an image including the plurality of item images displayed to the second user are different, and
the determining the at least one item image includes determining, based on frequency information indicating frequencies of operation for the respective plurality of item images in the display form of the image including the plurality of item images displayed to the first user, the at least one item image to be recommended as a target on which the first user perform operation.

7. An information processing apparatus comprising:
a processing device programmed to execute
acquiring operation information concerning operation by a first user in a state in which an image including a plurality of item images is displayed; and
when detecting, based on the operation information, a state in which the first user cannot determine on which item image among the plurality of item images the first user performs operation, determining, based on operation history information, at least one item image to be recommended as a target on which the first user perform operation among the plurality of item images, the operation history information being information concerning an item image which has been a target of operation performed by at least one of the first user and a second user different from the first user in the state in which the image including the plurality of item images is displayed.

8. A non-transitory computer-readable storage medium storing a program causing a processing device to execute:
acquiring operation information concerning operation by a first user in a state in which an image including a plurality of item images is displayed; and
when detecting, based on the operation information, a state in which the first user cannot determine on which item image among the plurality of item images the first user performs operation, determining, based on operation history information, at least one item image to be recommended as a target on which the first user perform operation among the plurality of item images, the operation history information being information concerning an item image which has been a target of operation performed by at least one of the first user and a second user different from the first user in the state in which the image including the plurality of item images is displayed.
